(19) United States
(12) Patent Application Publication
(10) Pub. No.: US 2014/0353965 A1
(43) Pub. Date: Dec. 4, 2014

(54) PIPE JOINT

(71) Applicant: HIGASHIO MECH CO., LTD., Kawachinagano (JP)

(72) Inventors: Yoshinori Inoue, Kawachinagano-shi (JP); Tamotsu Takada, Kawachinagano-shi (JP); Risa Ikemoto, Kawachinagano-shi (JP); Akio Yasuda, Kawachinagano-shi (JP)

(73) Assignee: HIGASHIO MECH CO., LTD., Kawachinagano-shi (JP)

(21) Appl. No.: 14/365,769

(22) PCT Filed: Oct. 24, 2012
(86) PCT No.: PCT/JP2012/077481

§ 371 Date: Jun. 16, 2014

(30) Foreign Application Priority Data
May 11, 2012 (JP) 2012-109725
Jul. 10, 2012 (JP) 2012-154463

(51) Int. Cl. F16L 47/04; F16L 19/08

(52) U.S. Cl. CPC F16L 47/04; F16L 19/083
USPC 285/322; 285/342

(57) ABSTRACT

To provide a pipe joint with which the construction is made simple and compact, and basic sealing ability and resistance to pipe drawing force are shown, the pipe joint is composed only two parts of a pipe joint main body 2 and an outer cylinder body 5, the pipe joint main body 2 has an inserted cylinder portion 4 having independent ridges 11, and the outer cylinder body 5 has an inner screw thread 7. The outer cylinder body 5 screws and forms a spiral groove 20 on a peripheral face of a pipe P, and connects to the pipe joint main body 2 in a final fastened state.

### FIELD OF THE INVENTION

This invention relates to a pipe joint.

### BACKGROUND ART

Although various pipe joints are conventionally proposed, they have been becoming joints having large number of parts and complicated constructions.

For example, the applicant of the present application has proposed a pipe joint having a construction as shown in FIG. 12 (refer to patent document 1). That is to say, the pipe joint shown in FIG. 12 is to propose a pipe joint having a construction provided with a joint main body 32 having an inserted cylinder portion 33 inserted to an end portion of a pipe 31 to be connected, a sealing member 34 attached to a concave peripheral groove 37 of the inserted cylinder portion 33, a fastening ring body 35 with a slit 51 to fasten the end portion of the pipe 31 mounted to the inserted cylinder portion 33 with elastic fastening force, a diameter-expansion piece 36 detachably held by end portions of the slit 51 and resisting to elastic force of the fastening ring body 35 as to expand the fastening ring body 35 in diameter and detached by contact with a forth end portion of the inserted pipe 31, and a stop ring 38 of which inner peripheral side hitches to the peripheral face of the pipe 31 mounted to the inserted cylinder portion 33 to stop drawing.

The conventional pipe joint as shown in FIG. 12 described above can show very stable and strong pipe drawing force by the fastening ring body 35 fastening with strong elastic force and the stop ring 36 (having many teeth portions 42), and has an advantage of stable sealing ability by the sealing member 34.

However, unitization work in which the diameter-expansion piece 36 is preliminarily attached to the slit 51 of the fastening ring body 35 is necessary, and an outer cylindrical body 39 and a cap nut 40 have to be assembled by screwing. These cause problems that the assemble work causes much labor, the outer dimension of the joint becomes large, and the cost becomes high with a large number of parts.

And, as a conventional pipe joint with simple construction and small number of parts, a joint as shown in FIG. 13 is known (refer to non-patent document 1). This pipe joint shown in FIG. 13 has a construction in which a sleeve 44 of short cylinder of metal such as brass is mounted to an end portion of a plastic pipe 43, and an inserted cylinder portion 46 (without sealing member) of a joint main body 45 is strongly press-fit in a diminishing direction of diameter to be connected.

In this conventional pipe joint, the end portion of the pipe 43 is expanded in diameter as shown with arrows p as in FIG. 13(A) and (B) using a jig for expansion not shown, the inserted cylinder portion 46 is inserted to the end portion of the pipe 43, then, using a drawing tool provided with a pair of U-shaped arms to hitch to an outer brim portion 47 of the joint main body 45 and an end face of the sleeve 44, external force F for drawing the outer brim portion 47 and the sleeve 44 is given as shown in FIG. 13(C), the sleeve 44 is made strongly mounted, and the end portion of the pipe 43 and the inserted cylinder portion 46 are fastened to complete the connection.

### PRIOR ART DOCUMENT

### Patent Document

Patent document 1: Japanese Patent NO. 3411546.

### Non-Patent Document

Non-patent document 1: HP of MIRAI INDUSTRY CO., LTD. “W-type joint for supplying water” (pages 54, 55, and 72 of electronic catalog) <URL:http://www.mirai.co.p/kanzai/catalog/_SWF_Window.html>

### OUTLINE OF THE INVENTION

### Problems to be Solved by the Invention

However, in the pipe joint shown in FIG. 13, the special drawing tool provided with a pair of U-shaped arms is necessary to give the external force shown with arrows F in the connecting work, skill is required, and working in narrow spaces and in altitude is quite difficult. Further, brass normally used for the sleeve 44 may breaks after a period of time by stress, corrosion, and cracking, and reliability of quality is made low thereby.

It is an object of the present invention to provide a pipe joint with a small number of parts, high sealing ability, high drawing resistance, stable quality, and reliability to solve all of the conventional problems described above. Further, it is another object of the present invention to provide a pipe joint with which connecting work can be easily conducted (even in narrow spaces and in altitude) with generally-used tools.

### Means for Solving the Problems

Therefore, the present invention is provided with a pipe joint main body, having an inserted cylinder portion tapered to diminish in diameter toward a forth end and inserted to an end portion of a pipe composed of resin, in which plural ring independent ridges are formed on a peripheral face of the inserted cylinder portion; and an outer cylinder body, having an inner screw thread screwing and forming a spiral groove on a peripheral face of the end portion of the pipe, to which the inserted cylinder portion tapered to diminish in diameter toward the forth end is inserted, with elastic deformation and plastic deformation of the resin.

And, an automatic hitching-connecting means, to connect the outer cylinder body and the pipe joint main body when the outer cylinder body becomes a final fastened state by the screwing, is attached.

And, the automatic hitching-connecting means is composed of an arc-shaped hitching protruding piece portion having a first hitching claw portion protruding from a staged face near a base end of the inserted cylinder portion in the pipe joint main body, and a second hitching claw portion formed on a base end side of the outer cylinder body and hitching to the first hitching claw portion.

And, the inserted cylinder portion is coated by a pre-coated sealing layer.

### Effects of the Invention

According to the present invention, the pipe joint can sufficiently resist to pipe drawing force with small number of parts, and show stable sealing ability. And, connecting work can be easily conducted with generally-used tools such as a spanner.

### BRIEF DESCRIPTION OF THE DRAWINGS

FIG. 1 A cross-sectional exploded view showing an embodiment of the present invention.

FIG. 2 A cross-sectional view showing a used state.

FIG. 3 A cross-sectional view showing the used state.

FIG. 4 A cross-sectional view showing a state in which an inserted cylinder portion is inserted to an end portion of a pipe.

FIG. 5 A cross-sectional side view showing a transitional state of fastening by an outer cylinder body 5.

FIG. 6 A cross-sectional view showing a final fastened state.

FIG. 7 A half cross-sectional view showing another embodiment of the present invention.

FIG. 8 A side view of a pipe joint main body.

FIG. 9 An enlarged cross-sectional explanatory view of a principal portion.

FIG. 10 An enlarged cross-sectional view of a principal portion to explain the used state.

FIG. 11 An enlarged cross-sectional view of a principal portion to show the final fastened state.

FIG. 12 A cross-sectional front view showing a conventional example.

FIG. 13 A cross-sectional explanatory view showing another conventional example.

### EMBODIMENTS OF THE INVENTION

The present invention will now be described with reference to the embodiments shown in the accompanying drawings.

In FIGS. 1 through 6, showing an embodiment of the present invention, a mark P represents a pipe to be connected composed of resin, a pipe joint 10 relating to the present invention is composed of 2 parts, namely, a pipe joint main body 2 and an outer cylinder body 5 freely connected to the pipe joint main body 2.

The pipe joint main body 2 has a protruding inserted cylinder portion 4, tapered as to diminish in diameter to a forth end, to be inserted to an end portion 3 of the pipe P. Plural independent ridges 11 are formed on a peripheral face of the inserted cylinder portion 4. Further, a hexagonal portion 13 is continuing from a portion near a base end of the inserted cylinder portion 4 through a staged face 12, and a male screw cylinder portion 14 is continuing from the hexagonal portion 13.

A duct hole 15 is formed along an axis L₂. The duct hole 15 has a large diameter on a side on the male screw cylinder portion 14 and a small inner diameter dimension d on a side on the inserted cylinder portion 4 with a staged portion 16 within the hexagonal portion 13.

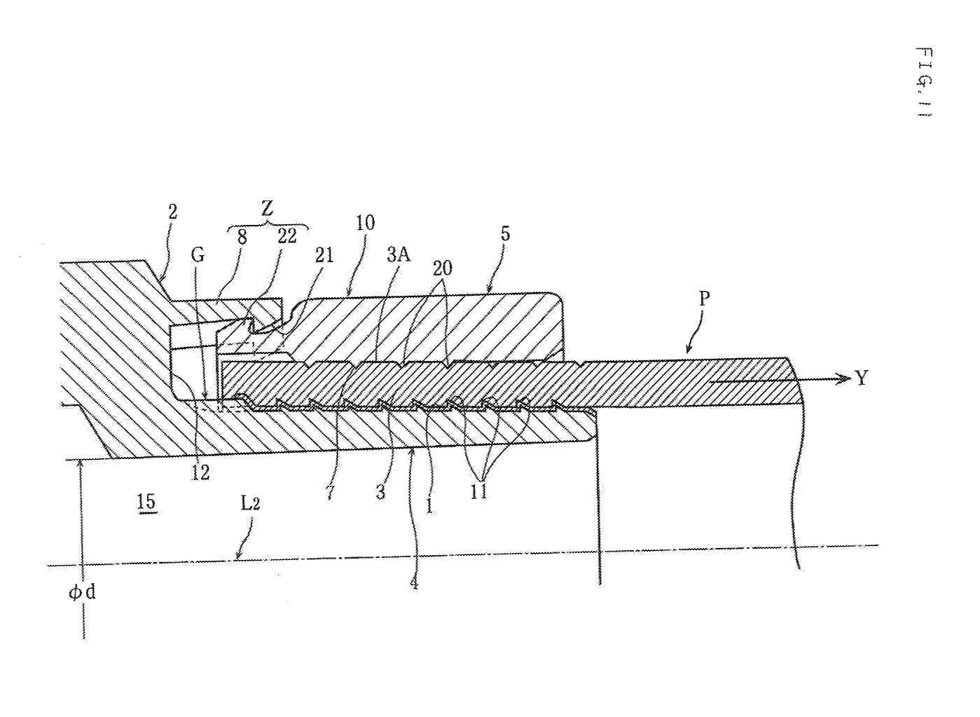

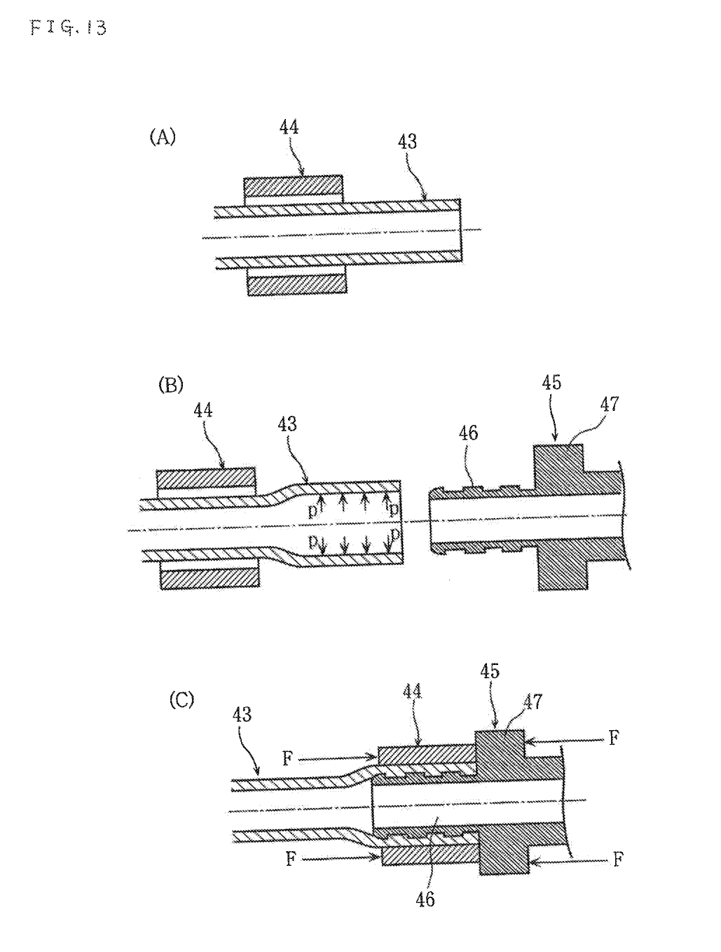

The independent ridge 11 on the peripheral face of the inserted cylinder portion 4 is triangular, preferably triangular inclining in a direction toward the base end as the pipe P after the connection is hardly drawn out. Although not shown in FIGS. 1 and 4 through 6, it is also preferable to coat the peripheral face of the inserted cylinder portion 4 with a pre-coated sealing layer 1 (described below with FIG. 9, etc.). And, sealing grooves and sealing members (0-rings, etc.) are omitted, and a thickness dimension of the inserted cylinder portion 4 is set sufficiently thin in comparison with the conventional example in FIG. 12. That is to say, the inner diameter dimension d of the inserted cylinder portion 4 can be sufficiently larger than the inner diameter dimension d of the conventional pipe joint in FIG. 12, fluid passing resistance is small, and pressure loss can be reduced.

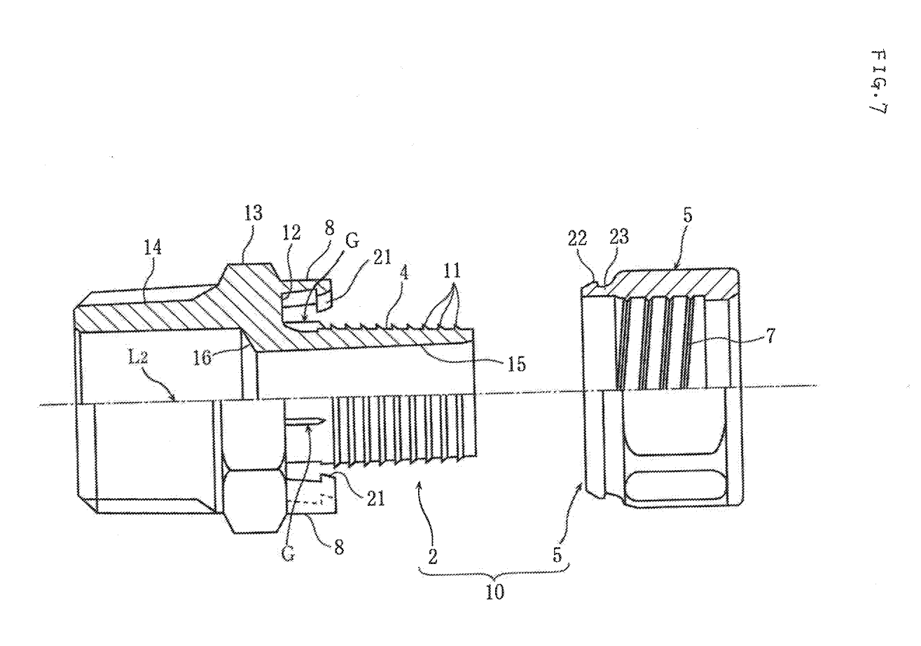

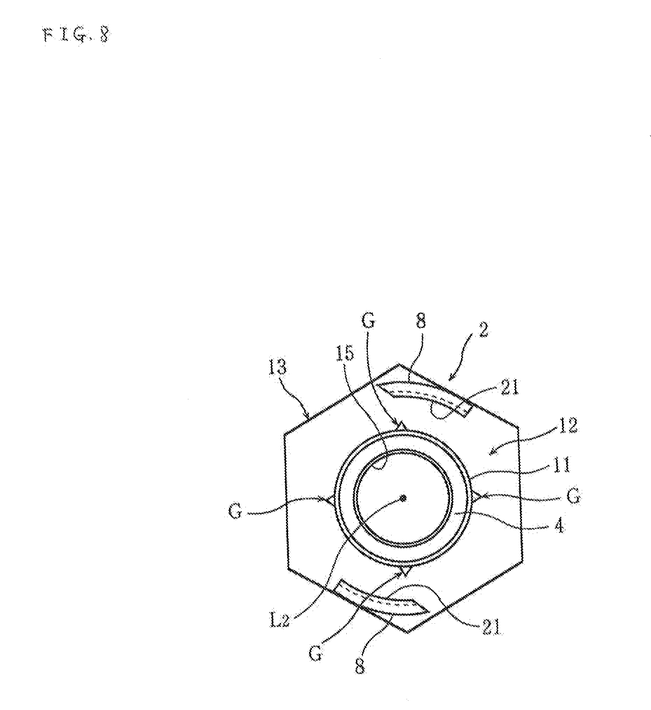

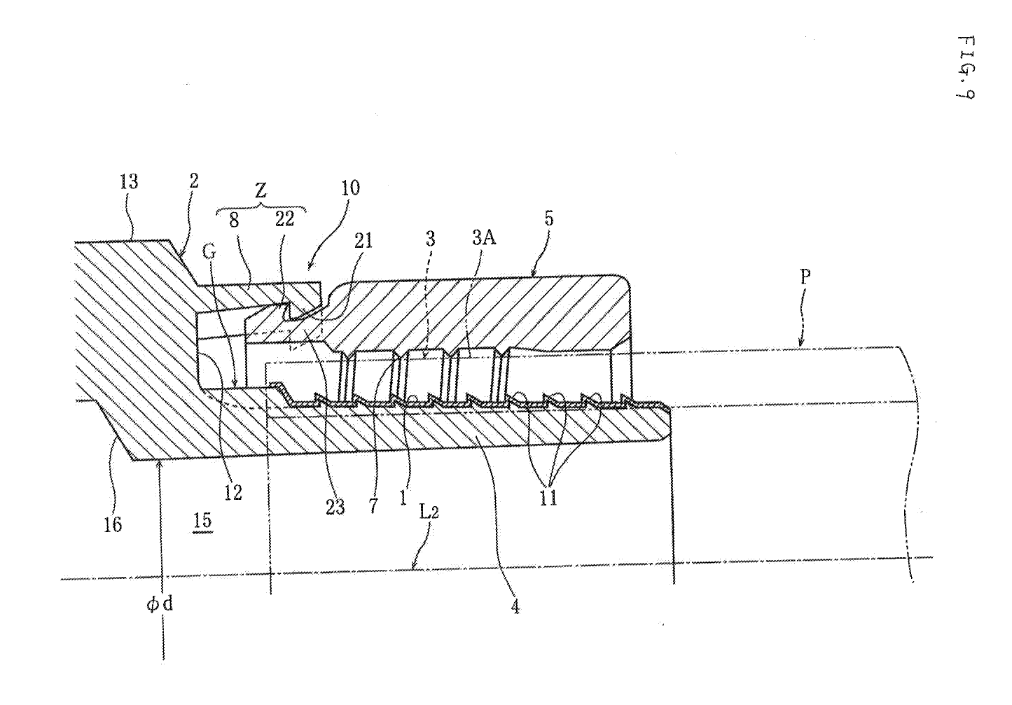

And, the outer cylinder body 5 has an inner screw thread 7 screwing (as shown with an arrow M) and forming a spiral groove 20 on a peripheral face 3A of the end portion 3 of the pipe P, to which the inserted cylinder portion 4 tapered to diminish in diameter toward the forth end is inserted, with elastic deformation and plastic deformation of the resin as shown in FIG. 5 and FIG. 6. And, the outer cylinder body 5 has a configuration of which outer face is hexagonal as to be easily given rotational torque in the arrow M direction (refer to FIG. 5) by general working tools such as spanners and wrenches.

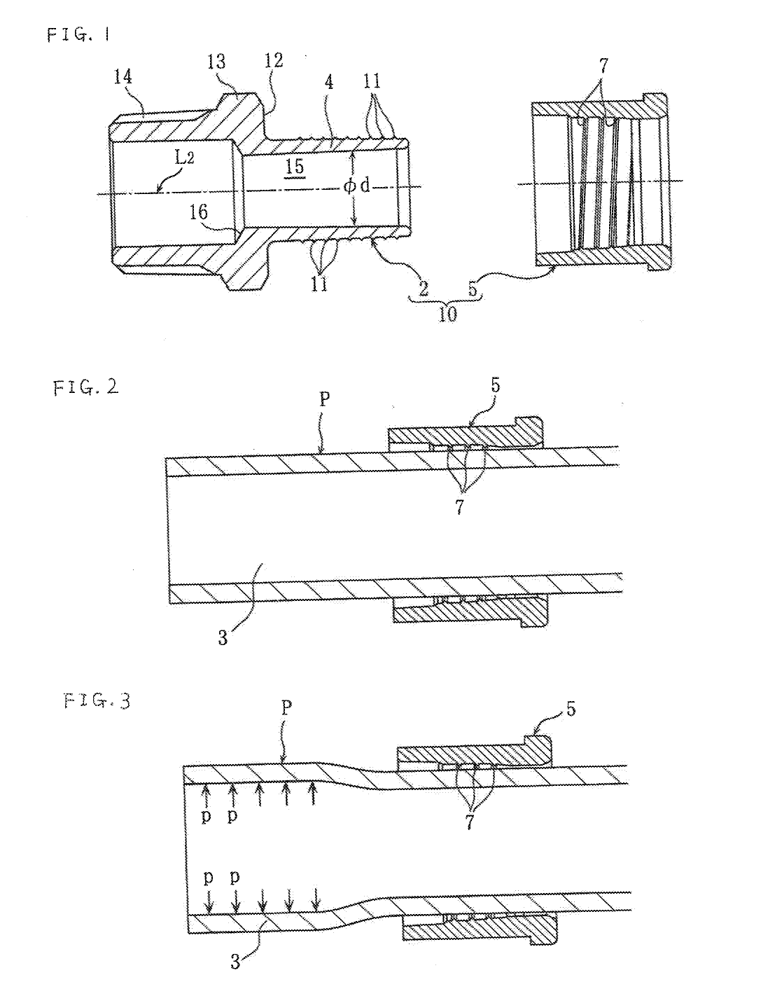

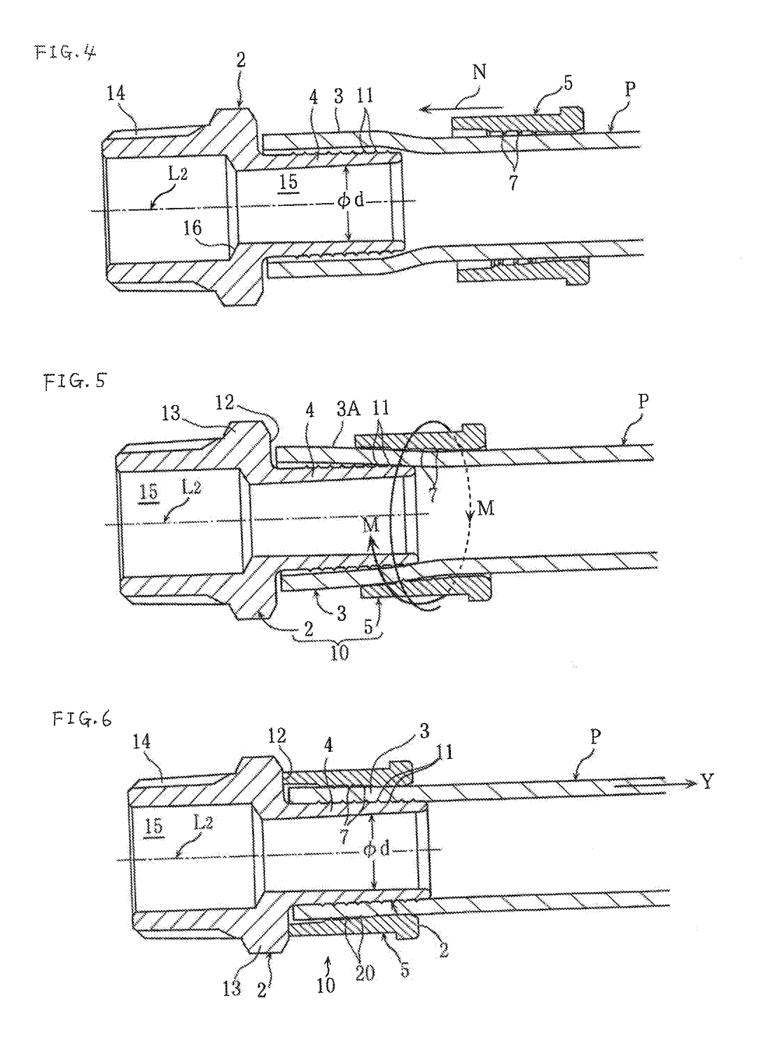

As shown in FIG. 2, the outer cylinder body 5 is preliminarily mounted to the pipe P, then, as shown in FIG. 3, external force is given to the inner peripheral face of the pipe end portion 3 in arrows p directions by (conventional and known) diameter-expanding tool as the inserted cylinder portion 4 can be smoothly inserted, and after this, the inserted cylinder portion 4 is inserted to the end portion 3 as shown in FIG. 4. Then, as the outer cylinder body 5 is slid as shown with an arrow N in FIG. 4 and screwed in the arrow M direction by general working tool such as a spanner as shown in FIG. 5, the pipe end portion 3 is slightly squeezed in diminishing directions, and the inner screw thread 7 of the outer cylinder body 5 screws forming a spiral groove 20 on a peripheral face 3A of the end portion 3 of the pipe P with elastic deformation and plastic deformation of the resin.

The inserted cylinder portion 4, tapered to diminish toward the forth end, increases the outer diameter dimension toward the base end, the pipe end portion 3 is already expanded in diameter toward the base end side under the state of FIG. 5, as the outer cylinder body 5 on the outside screws in the arrow M direction, the inner screw thread 7 forms the spiral groove 20 as to gradually and deeply bite into the peripheral face of the pipe P, and strong resistance against drawing force (external force) in an arrow Y direction is shown by cooperation of (the independent ridges 11 of) the inserted cylinder portion 4 and the inner screw thread 7.

The material of the pipe joint main body 2 and the outer cylinder body 5 is preferably PPSU, PSU, etc., and PEX (bridged polyethylene), PE, PB, a compound pipe (a resin pipe including metal layer) are appropriate as the material of the pipe P. The hardness of the outer cylinder body 5 is set to be higher than that of the pipe P to let the inner screw thread 7 certainly form the spiral groove 20 on the peripheral face of the pipe P.

Next, FIGS. 7 through 11 show another embodiment of the present invention. Also in FIGS. 7 through 11, a pipe joint 10 is composed of (2 parts of) a pipe joint main body 2 and an outer cylinder body 5 freely connected to the pipe joint main body 2.

The pipe joint main body 2 has a protruding inserted cylinder portion 4, tapered as to diminish in diameter to a forth end, to be inserted to an end portion 3 of the pipe P, and plural independent ridges 11 are formed on a peripheral face of the inserted cylinder portion 4. Further, a hexagonal portion 13 is continuing from a portion near a base end of the inserted cylinder portion 4 through a staged face 12, and a male screw cylinder portion 14 is continuing from the hexagonal portion 13.

A duct hole 15 is formed along an axis L₂. The duct hole 15 has a large diameter on a side on the male screw cylinder portion 14 and a small inner diameter dimension d on a side on the inserted cylinder portion 4 with a staged portion 16 within the hexagonal portion 13.

The independent ridge 11 on the peripheral face of the inserted cylinder portion 4 is triangular, preferably triangular inclining in a direction toward the base end as the pipe P after the connection is hardly drawn out. And, the peripheral face of the inserted cylinder portion 4 is coated by a pre-coated sealing layer 1, sealing grooves and sealing members (0-rings, etc.) are omitted, and a thickness dimension of the inserted cylinder portion 4 is set sufficiently thin in comparison with the conventional example in FIG. 12. That is to say, the inner diameter dimension d of the inserted cylinder portion 4 can be sufficiently larger than the inner diameter dimension d of the conventional pipe joint in FIG. 12, fluid passing resistance is small, and pressure loss can be reduced.

The pre-coated sealing layer 1 is preliminarily coated in factories of the pipe joint 10 or its parts (not in working cites). The material of the pre-coated sealing layer 1 is formed with a bridged pre-coated sealing agent based on fluoropolymer of which film as an elastic body having appropriate softness shows excellent sealing function (sealing ability). For example, EIGHT SEAL AC-505 of TAIHEI KASEI CO., LTD. in market can be applied.

And, the outer cylinder body 5 has an inner screw thread 7 screwing (as shown with an arrow M) and forming a spiral groove 20 on a peripheral face 3A of the end portion 3 of the pipe P, to which the inserted cylinder portion 4 tapered to diminish in diameter toward the forth end is inserted, with elastic deformation and plastic deformation of the resin as shown in FIG. 10. And, the outer cylinder body 5 has a configuration of which outer face is hexagonal as to be easily given rotational torque in the arrow M direction (refer to FIG. 10) by general working tools such as spanners and wrenches.

As shown in FIG. 10, the outer cylinder body 5 is preliminarily mounted to the pipe P, then, the inserted cylinder portion 4 is pushed to be inserted to the end portion 3 of the pipe P (in this process, later-described small ridges G bite into the inner peripheral face of the end portion 3 of the pipe P). Then, the outer cylinder body 5 is slid as shown with the arrow N and rotated in the arrow M direction by working tool such as a spanner to screw.

A mark G represents a small ridge in axial direction for preventing co-rotation of the pipe. Plural small ridges G are protruding from the peripheral face of the base end of the inserted cylinder portion 4. The forth end of the pipe P can be certainly prevented from rotating (co-rotating) by the small ridges G when the outer cylinder body 5 is screwed as shown with the arrow M.

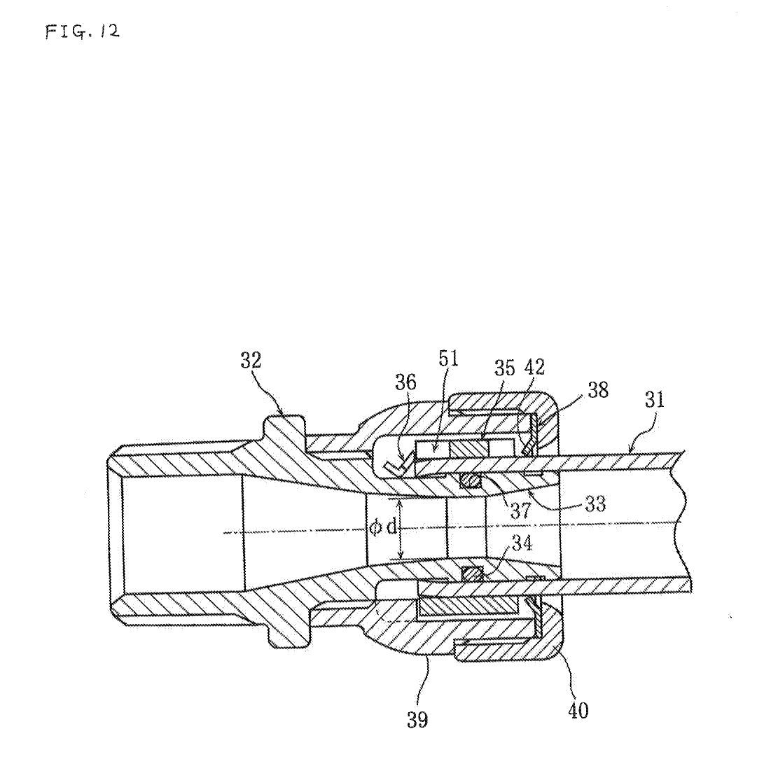

And, an automatic hitching-connecting means Z, which connects the outer cylinder body 5 and the pipe joint main body 2 when a final fastened state shown in FIG. 11 is made by the screwing of the outer cylinder body 5 as shown with the arrow M in FIG. 10, is set.

The automatic hitching-connecting means Z, in the pipe joint main body 2, is composed of an arc-shaped hitching protruding piece portion 8 having a first hitching claw portion 21 protruding from the staged face 12, and a second hitching claw portion 22 formed on the base end side of the outer cylinder body 5. The base end side of the outer cylinder body 5 is formed into a thin cylindrical portion 23, and the hook-shaped second hitching claw portion 22 is protruding from a peripheral face on the most base end of the thin cylindrical portion 23.

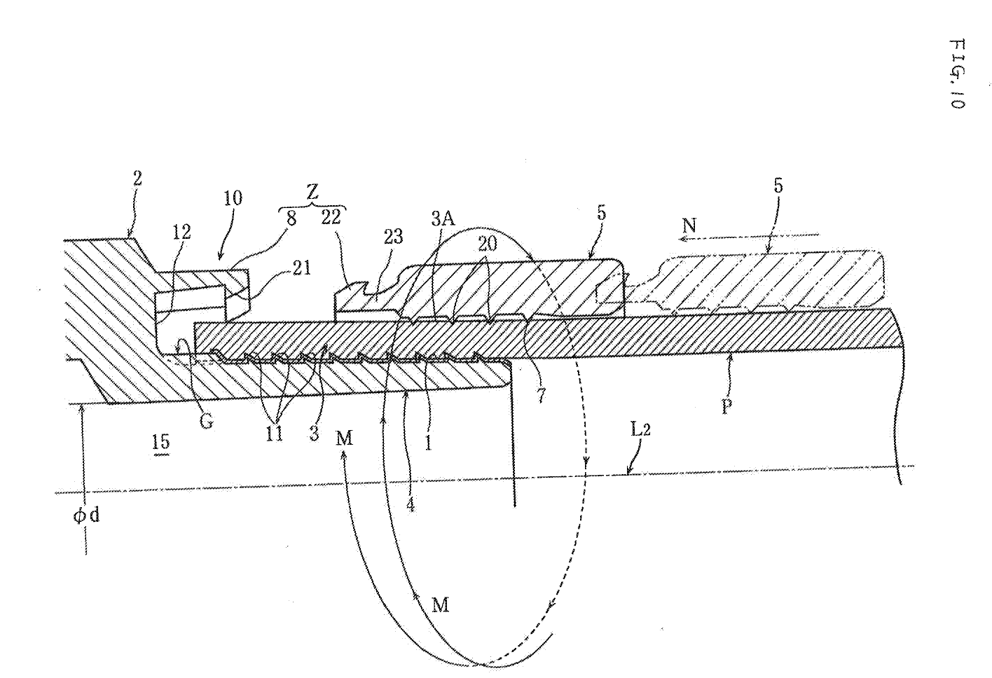

Concretely, as shown in FIG. 8, two arc-shaped hitching protruding piece portions 8 are disposed on positions opposite for 180° to be rotation symmetric, the first hitching claw portion 21 is hook-shaped and protruding in a radial inner direction. The first hitching claw portion 21 and the second hitching claw portion 22 hitch each other when the final fastened state shown in FIG. 11 is made, and the outer cylinder body 5 firmly keeps the connected state with the pipe joint main body 2 when drawing force (external force) in an arrow Y direction in FIG. 11 works on the pipe P. Further, the outer diameter dimension of the inserted cylinder portion 4, tapered to diminish in diameter toward the forth end, increases toward the base end, and the pipe base end 3 is already increasing in diameter to the base end side under the state of FIG. 10. When the outer cylinder body 5 is screwed in the arrow M direction from the outside of the pipe P, the inner screw thread 7 forms the spiral groove 20 as biting gradually into the peripheral face of the pipe P, and strong resistance to the drawing force (external force) in an arrow Y direction is shown by cooperation of the inserted cylinder portion 4 (the independent ridges 11) and the inner screw thread 7. In this case, the resistance to the drawing force of the pipe P is made stable and strong because the outer cylinder body 5 is not moved in the axial direction (the arrow Y direction) with the above-described automatic hitching-connecting means Z.

The material of the pipe joint main body 2 and the outer cylinder body 5 is as described above, and the hardness of the outer cylinder body 5 is set to be higher than that of the pipe P to certainly form the spiral groove 20 on the peripheral face of the pipe P by the inner screw thread 7.

Although the pipe joint 10 of which construction has the male screw cylinder portion 14 (on the left side of the pipe joint main body 2) is shown in FIG. 7, the present invention may have various constructions and configurations like following examples.

(i) A case composed of a staged face 12 on a cylindrical body protruding from a fluid appliance, etc., an arc-shaped hitching protruding piece portion 8 protruding from the staged face 12, an inserted cylinder portion 4 protruding from the staged face 12, and an outer cylinder body 5 mutually hitched (connected) to the inserted cylinder portion 4 through an automatic hitching-connecting means Z.

(ii) A case in which a left half is made symmetric with a right half with a central cutting face of the hexagonal portion 13 as a plane of symmetry. That is to say, a construction in which a pair of inserted cylinder portions 4 and a pair of outer cylinder bodies 5 are formed.

(iii) A case in which an elbow pipe portion and an attachment flange portion are formed instead of the male screw cylinder portion 14 in the pipe joint main body 2 in FIG. 7.

(iv) A case in which a conventionally-known connecting mechanism is used.

The above-described (ii)(iii)(iv) may be also similarly applied to the embodiment in FIG. 1.

With the present invention, the number of parts can be reduced, the product can be manufactured economically and easily, strong resistance to the pipe drawing force is shown with a simple construction, and sealing ability is also sufficiently shown because the present invention has the construction as described above provided with the pipe joint main body 2, having the inserted cylinder portion 4 tapered to diminish in diameter toward the forth end and inserted to the end portion 3 of the pipe P composed of resin, in which the plural ring independent ridges 11 are formed on the peripheral face of the inserted cylinder portion 4; and the outer cylinder body 5, having the inner screw thread 7 screwing and forming the spiral groove 20 on the peripheral face 3A of the end portion 3 of the pipe P, to which the inserted cylinder portion 4 tapered to diminish in diameter toward the forth end is inserted, with elastic deformation and plastic deformation of the resin.

Further, the thickness dimension of the inserted cylinder portion 4 is small because sealing grooves and 0-rings are omitted from the inserted cylinder portion 4, and consequently, the inner diameter dimension d of the duct hole 15 is made larger than that of conventional products, passing resistance of fluid (water) is reduced, and pressure loss is reduced. And, it is also an advantage that a compact pipe joint can be obtained with reduced outer diameter dimension. And, conventional general-purpose tools such as a spanner can be used as working tools.

Especially, as shown in FIGS. 5 and 6, and in FIGS. 10 and 11, the inner screw thread 7 bites into the peripheral face of the pipe P along with the screwing of the outer cylinder body 5 (refer to the arrow M) and shows strong resistance to the pipe drawing force in the arrow Y direction. Further, the fastening force in the radial inner direction is given to the pipe P along with the screwing of the outer cylinder body 5 and sealing ability is made good because the inserted cylinder portion 4 is tapered to enlarge in diameter toward the base end direction and having the independent ridges 11.

As described above, the present invention is a pipe joint with which basic function of sealing ability is shown stably and sufficiently for a long period of time, and remarkably stable resistance to pipe drawing force and sealing ability can be shown in comparison with the pipe joint as shown in FIG. 13 as a conventional example. The present invention greatly contributes to enhancement of practical efficiency of connecting work and improvement of piping technology. And, with attachment of the automatic hitching-connecting means Z, the resistance to the pipe drawing force is certainly stabilized further.

And, the present invention has simple configuration and construction, there is an advantage that the completion of the connecting work can be certainly checked by eyes, and the outer cylinder body 5 can be automatically and easily prevented from moving outward in the axial direction with screwing because the automatic hitching-connecting means Z is composed of the arc-shaped hitching protruding piece portion 8 having the first hitching claw portion 21 protruding from the staged face 12 near the base end of the inserted cylinder portion 4 in the pipe joint main body 2, and the second hitching claw portion 22 formed on the base end side of the outer cylinder body 5 and hitching to the first hitching claw portion 21.

And, processes of painting of sealing compound and winding of sealing tape in working cites of pipe connection are unnecessary, and swift work can be conducted because the inserted cylinder portion 4 is coated by the pre-coated sealing layer 1.

### EXPLANATION OF THE MARKS

P A pipe
Z An automatic hitching-connecting means
1 A pre-coated sealing layer
2 A pipe joint main body
3 An end portion
3A A peripheral face
4 An inserted cylinder portion
5 An outer cylinder body
7 An inner screw thread
8 An arc-shaped hitching protruding piece portion
10 A pipe joint
11 An independent ridge
12 A staged face
20 A spiral groove
21 A first hitching claw portion
22 A second hitching claw portion

1: A pipe joint characterized by that:
a pipe joint main body (2), having an inserted cylinder portion (4) tapered to diminish in diameter toward a forth end and inserted to an end portion (3) of a pipe (P) composed of resin, in which plural ring independent ridges (11) are formed on a peripheral face of the inserted cylinder portion (4), and plural small ridges (G) in axial direction for preventing co-rotation of the pipe are formed on a peripheral face of a base end of the inserted cylinder portion (4); and
an outer cylinder body (5), having an inner screw thread (7) screwing and forming a spiral groove (20) on a peripheral face (3A) of the end portion (3) of the pipe (P), to which the inserted cylinder portion (4) tapered to diminish in diameter toward the forth end is inserted, with elastic deformation and plastic deformation of the resin; are provided.

2: The pipe joint as set forth in claim 1, wherein an automatic hitching-connecting means (Z), to connect the outer cylinder body (5) and the pipe joint main body (2) when the outer cylinder body (5) becomes a final fastened state by the screwing, is attached.

3: The pipe joint as set forth in claim 2, wherein the automatic hitching-connecting means (Z) is composed of an arc-shaped hitching protruding piece portion (8) having a first hitching claw portion (21) protruding from a staged face (12) near a base end of the inserted cylinder portion (4) in the pipe joint main body (2), and a second hitching claw portion (22) formed on a base end side of the outer cylinder body (5) and hitching to the first hitching claw portion (21).

4: The pipe joint as set forth in claim 1, wherein the inserted cylinder portion (4) is coated by a pre-coated sealing layer (1).

5: The pipe joint as set forth in claim 2, wherein the inserted cylinder portion (4) is coated by a pre-coated sealing layer (1).

6: The pipe joint as set forth in claim 3, wherein the inserted cylinder portion (4) is coated by a pre-coated sealing layer (1).
